(19) United States
(12) Patent Application Publication
(10) Pub. No.: US 2007/0057875 A1
(43) Pub. Date: Mar. 15, 2007

(54) Light emitting device and method of driving the same

(75) Inventor: Byoung Ik Kwon, Seongnam-city (KR)

Correspondence Address: FLESHNER & KIM, LLP, P.O. BOX 221200, CHANTILLY, VA, 20153, US

(73) Assignee: LG Electronics Inc.

(21) Appl. No.: 11/435,764

(22) Filed: May 18, 2006

(30) Foreign Application Priority Data
Sep. 13, 2005 (KR) 10-2005-0085237

(51) Int. Cl. G09G 3/30

(52) U.S. Cl. 345/76

(57) ABSTRACT

The present invention relates to a light emitting device for preventing cross-talk phenomenon by using dummy scan line coupled to data lines. The light emitting device includes data lines, scan lines, at least one dummy scan line and a dummy scan driving circuit. The data lines are disposed in a first direction, and the scan lines are disposed in a second direction different from the first direction. The dummy scan line is coupled to one or more data line. The dummy scan driving circuit couples the dummy scan line to a discharge source for a part of a precharge period of time. The light emitting device of the present invention controls the amount of charge precharged to data lines using a dummy scan line, and so a cross-talk phenomenon is not occurred in the light emitting device.

### BACKGROUND OF THE INVENTION

1. Field of the Invention

The present invention relates to a light emitting device and a method of driving the same. More particularly, the present invention relates to a light emitting device for preventing cross-talk phenomenon by using dummy scan line coupled to data lines and a method of driving the same.

2. Description of the Related Art

A light emitting device emits a light having a certain wavelength, and especially an organic electroluminescent device is self light emitting device.

FIG. 1A is a block diagram illustrating a common light emitting device.

In FIG. 1A, the light emitting device includes a panel 100, a controller 102, a first scan driving circuit 104, a second scan driving circuit 106, a discharging circuit 108, a precharging circuit 110 and a data driving circuit 112.

The panel 100 includes a plurality of pixels E11 to E44 formed in cross areas of data lines D1 to D4 and scan lines S1 to S4.

The controller 102 receives display data from an outside apparatus (not shown), and controls the scan driving circuits 104 and 106, the discharging circuit 108, the precharging circuit 110 and the data driving circuit 112 using the received display data.

The first scan driving circuit 104 transmits first scan signals to a part of scan lines S1 to S4, for example S1 and S3 under control of the controller 102.

The second scan driving circuit 106 transmits second scan signals to other scan lines S2 and S4 under control of the controller 102.

Hereinafter, first display data and second display data are assumed to be inputted in sequence to the controller 102.

The data driving circuit 112 provides first data currents corresponding to the first display data to the data lines D1 to D4 under control of the controller 102.

The discharging circuit 108 discharges the data lines D1 to D4 under control of the controller 102.

The precharging circuit 110 provides precharge currents corresponding to the second display data to the data lines D1 to D4 for a precharge period of time under control of the controller 102, thereby precharging the data lines D1 to D4.

The data driving circuit 112 provides second data currents corresponding to the second display data to the data lines D1 to D4 under control of the controller 102.

FIG. 1B is a view illustrating one pixel included in the light emitting device of FIG. 1A. FIG. 1C is a timing diagram illustrating scan signal and data signal in the light emitting device.

Hereinafter, a process of precharging a first data line D1 will be described in detail as an example of a process of precharging the data lines D1 to D4.

In FIG. 1B and FIG. 1C, the precharging circuit 110 provides precharge current Pl1 to the first data line D1 for a precharge period of time. Here, a second scan line S2 is connected to a non-luminescent source having the same magnitude V1 as a driving voltage Vcc of the light emitting device, and so the first data line D1 is precharged by the precharge current Pl1. On the other hand, overshooting phenomenon is occurred during a process of precharging the first data line D1 as shown in FIG. 1C. As a result, the first data line D1 is precharged up to higher gray scale than gray scale (40 percents, 40%) corresponding to the second display data at a start point of low logic area of a second scan signal SP2 as shown in A of FIG. 1C. Accordingly, a second pixel E12 emits a light having higher gray scale than gray scale corresponding to the second display data.

Hereinafter, a luminescent process when a first scan line S1 is connected to a ground will be compared with that when the second scan line S2 is connected to the ground. Here, it is assumed that pixels E21 and E31 of the pixels E11 to E41 do not emit a light.

The pixels E11 and E41 emit light having higher gray scale than desired gray scale by a first level when the first scan line S1 is connected to the ground.

The pixels E12 to E42 emit light having higher gray scale than desired gray scale by a second level when the second scan line S2 is connected to the ground. Here, the second level is smaller than the first level. Accordingly, though a pixel E11 corresponding to the first scan line S1 is designed to have same gray scale as a pixel E12 corresponding to the second scan line S2, the pixel E11 has higher brightness than the pixel E12. This phenomenon is referred to as “cross-talk phenomenon”.

### SUMMARY OF THE INVENTION

It is a feature of the present invention to provide a light emitting device where cross-talk phenomenon is not occurred.

A light emitting device according to one embodiment of the present invention includes data lines, scan lines, at least one dummy scan line and a dummy scan driving circuit. The data lines are disposed in a first direction, and the scan lines are disposed in a second direction different from the first direction. The dummy scan line is coupled to one or more data line. The dummy scan driving circuit couples the dummy scan line to a discharge source for a part of a precharge period of time.

A light emitting device according to another embodiment of the present invention includes data lines, scan lines, a precharge circuit and a dummy scan driving circuit. The data lines are disposed in a first direction, and the scan lines are disposed in a second direction different from the first direction. The precharging circuit provides precharge current to at least one data line for a precharge period of time. The dummy scan driving circuit discharges the data line precharged by the precharge current for some of the prechage period of time.

A method of driving a light emitting device having a plurality of pixels formed in cross areas of data lines and scan lines according to one embodiment of the present invention includes providing precharge current to one or more data line for a precharge period of time, thereby precharging the data line; and discharging the precharged data line for some of the precharge period of time.

A method of driving a light emitting device having a plurality of pixels formed in cross areas of data lines and scan lines according to another embodiment of the present invention includes providing precharge current to one or more data line for a precharge period of time, thereby precharging the data line; and providing data current to the precharged data line. Here, waveform of the precharge current has an upward slope for a first sub precharge period of time of the precharge period of time, and has a downward slope for a second sub precharge period of time of the precharge period of time.

As described above, a light emitting device and a method of driving the same of the present invention control the amount of charge precharged to data lines using a dummy scan line, and so a cross-talk phenomenon is not occurred in the light emitting device.

### BRIEF DESCRIPTION OF THE DRAWINGS

The above and other features and advantages of the present invention will become readily apparent by reference to the following detailed description when considered in conjunction with the accompanying drawings wherein:

FIG. 1A is a block diagram illustrating a common light emitting device;

FIG. 1B is a view illustrating one pixel included in the light emitting device of FIG. 1A;

FIG. 1C is a timing diagram illustrating scan signal and data signal in the light emitting device;

FIG. 2 is a block diagram illustrating a light emitting device according to one embodiment of the present invention

FIG. 3A is a view illustrating a circuitry of one pixel included in the light emitting device in FIG. 2;

FIG. 3B is a timing diagram illustrating scan signal, dummy scan signal and data signal according to one embodiment of the present invention; and

FIG. 4 is a block diagram illustrating a light emitting device according to another embodiment of the present invention.

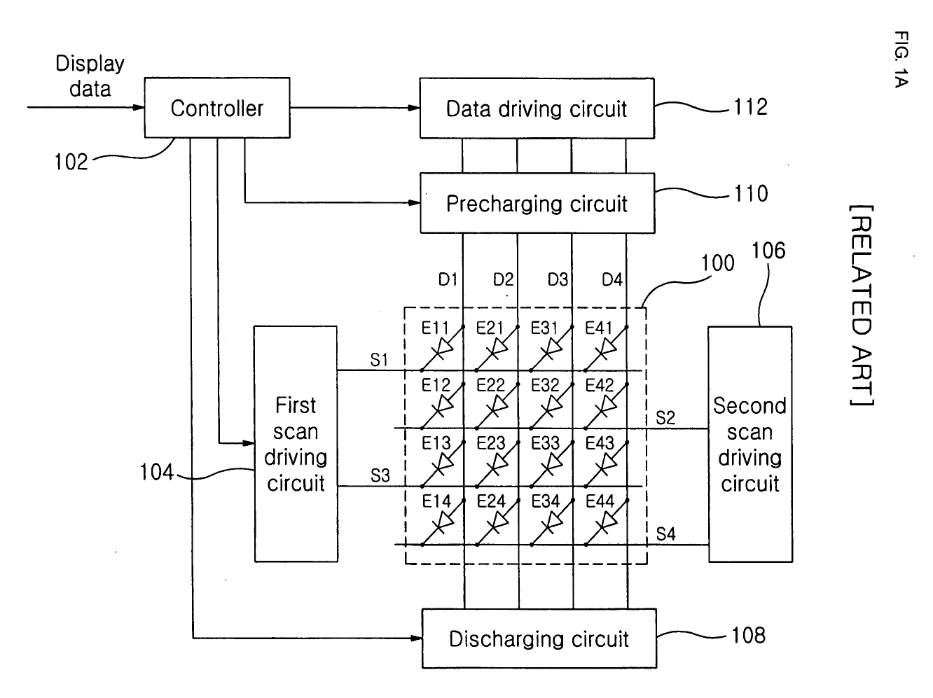

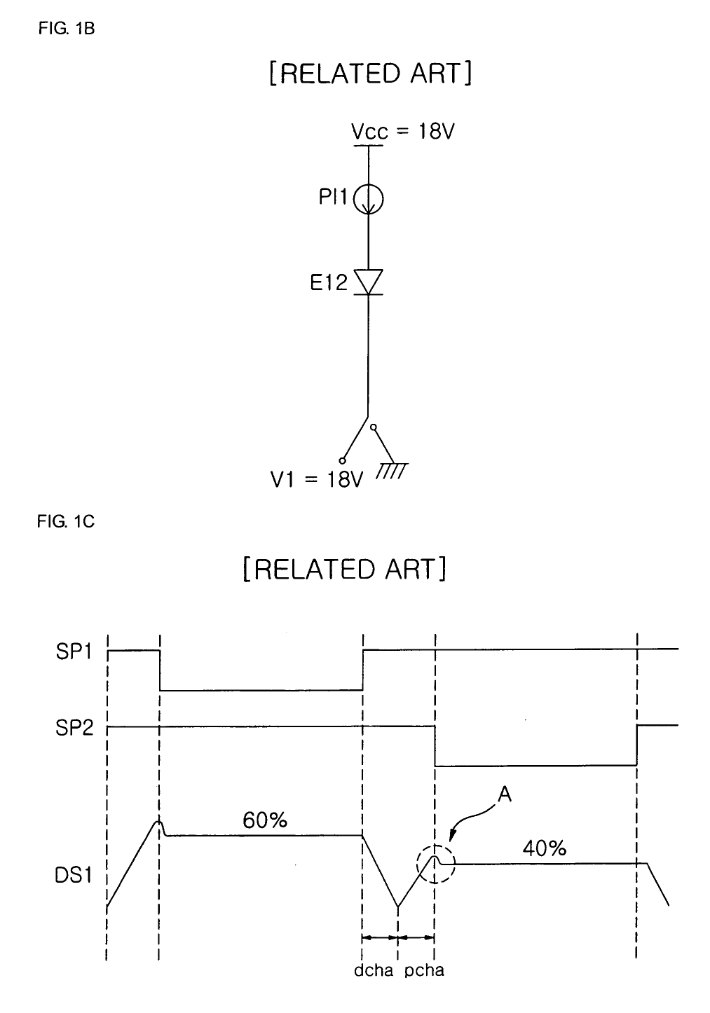

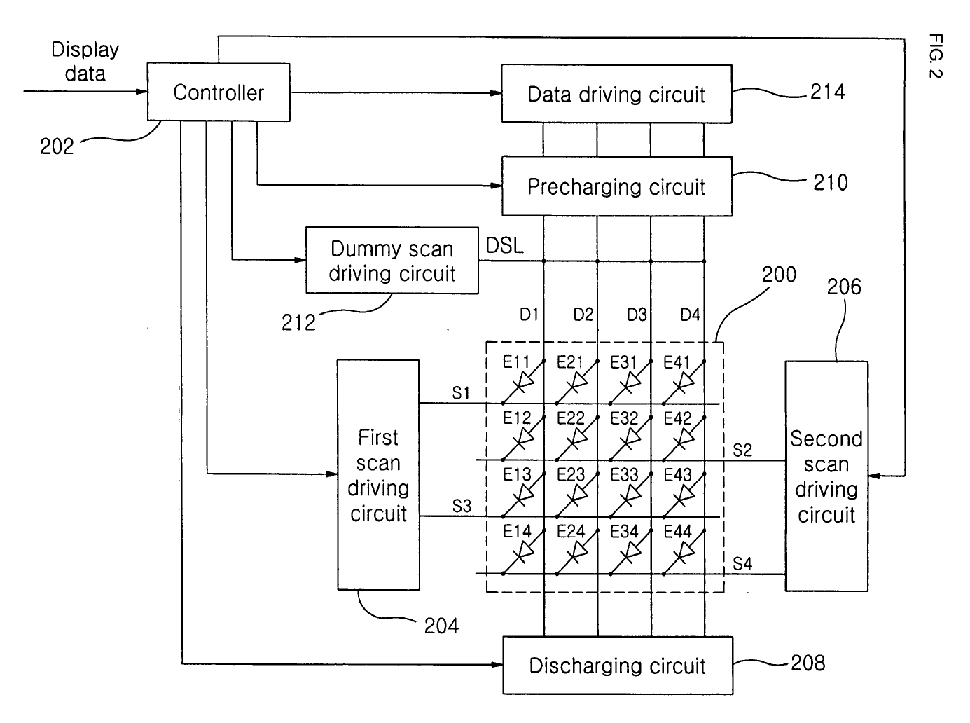

### DESCRIPTION OF EMBODIMENTS

Hereinafter, the preferred embodiments of the present invention will be explained in more detail with reference to the accompanying drawings.

FIG. 2 is a block diagram illustrating a light emitting device according to one embodiment of the present invention.

In FIG. 2, the light emitting device of the present invention includes a panel 200, a controller 202, a first scan driving circuit 204, a second scan driving circuit 206, a discharging circuit 208, a precharging circuit 210, a dummy scan driving circuit 212 and a data driving circuit 214.

The light emitting device according to one embodiment of the present invention includes an organic electroluminescent device, a plasma display panel, a liquid crystal display, and others. Hereinafter, the organic electroluminescent device will be described as an example of the light emitting device for convenience of the description.

The panel 200 includes a plurality of pixels E11 to E44 formed in cross areas of data lines D1 to D4 and scan lines S1 to S4.

At least one pixel includes an anode electrode layer, an organic layer and a cathode electrode layer deposited in sequence on a substrate (not shown). Here, the organic layer includes a hole transporting layer HTL, an emitting layer EML and an electron transporting layer ETL.

The controller 202 receives display data, e.g. RGB data from an outside apparatus (not shown), and controls the scan driving circuits 204 and 206, the discharging circuit 208, the precharging circuit 210, the dummy scan driving circuit 212 and the data driving circuit 214.

The first scan driving circuit 204 transmits first scan signals to a part of the scan lines S1 to S4, e.g. S1 and S3 under control of the controller 202.

The second scan driving circuit 206 transmits second scan signals to other scan lines S2 and S4 under control of the controller 202.

Hereinafter, first display data and second display data are assumed to be inputted in sequence to the controller 202.

The data driving circuit 214 provides first data currents, i.e. first data signals corresponding to the first display data to the data lines D1 to D4 under control of the controller 202.

The discharging circuit 208 discharges the data lines D1 to D4 under control of the controller 202.

The precharging circuit 210 provides precharge current corresponding to the second display data to the data lines D1 to D4 for a precharge period of time under control of the controller 202, thereby precharging the data lines D1 to D4.

The dummy scan driving circuit 212 transmits a dummy scan signal to a dummy scan line DSL coupled to the data lines D1 to D4. In this case, because the dummy scan line DSL is coupled to a discharge source, e.g. ground for a part of the precharge period of time, the precharged data lines D1 to D4 are discharged. This will be described in detail with reference to the accompanying drawings.

In a light emitting device according to another embodiment of the present invention, dummy scan lines may be coupled to the data lines D1 to D4, respectively. In other words, at least one dummy scan line DSL is coupled to the data lines D1 to D4.

The data driving circuit 214 provides second data currents corresponding to the second display data to the data lines D1 to D4 under control of the controller 202.

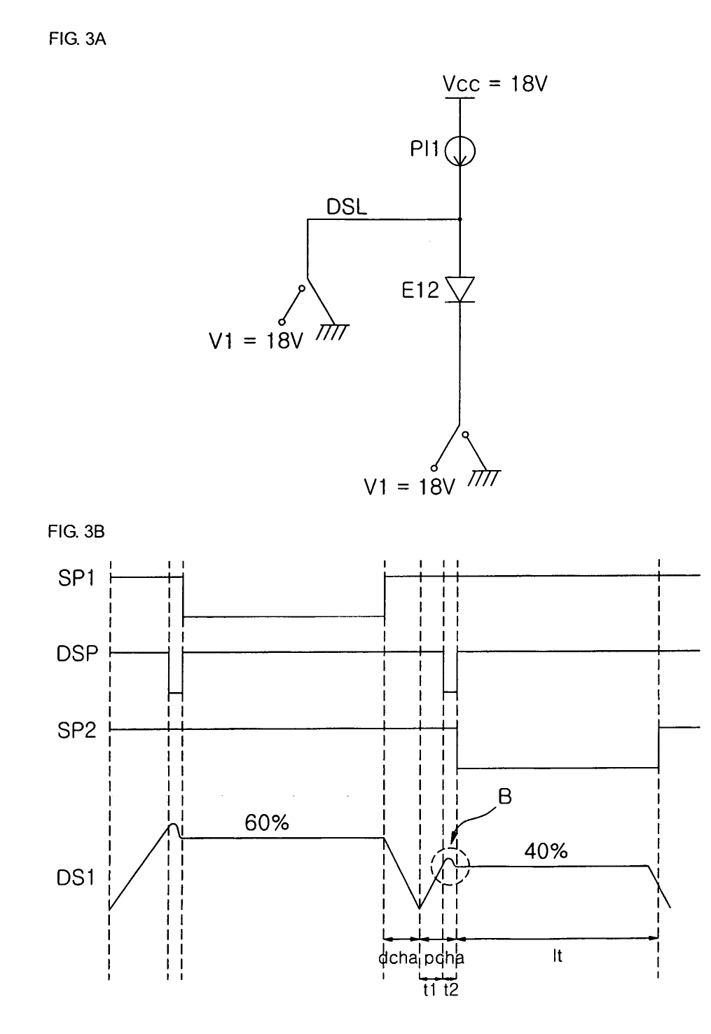

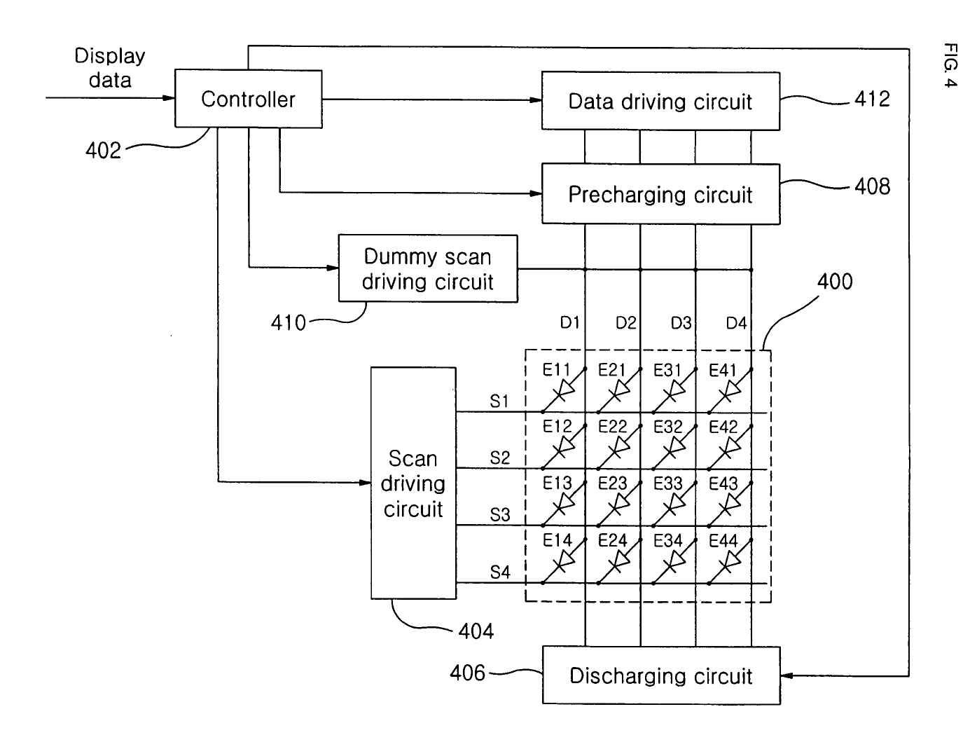

FIG. 3A is a view illustrating a circuitry of one pixel included in the light emitting device in FIG. 2. FIG. 3B is a timing diagram illustrating scan signal, dummy scan signal and data signal according to one embodiment of the present invention.

As shown in FIG. 3A, one terminal of the dummy scan line DSL is coupled to the first data line D1, and other terminal of the dummy scan line DSL is coupled to a non-discharge source having the same magnitude V1 as a driving voltage Vcc of the light emitting device or the discharge source, e.g. ground.

Hereinafter, a process of the driving the light emitting device of the present invention will be described in detail with reference to the first data line D1. Here, first display data and second display data are assumed to be inputted in sequence to the controller 202.

Firstly, the data driving circuit 214 provides first data current corresponding to the first display data to the first data line D1 under control of the controller 202.

Then, the discharging circuit 208 discharges the first data line D1 under control of the controller 202.

Subsequently, as shown in FIG. 3A, the precharging circuit 210 provides precharge current Pl1 corresponding to the second display data to the first data line D1 for a precharge period of time under control of the controller 202.

Hereinafter, a process of precharging the first data line D1 will be described in detail with reference to a first sub precharge period of time t1 and a second sub precharge period of time t2.

The second scan line S2 is coupled to a non-luminescent source having the same magnitude V1 as the driving voltage Vcc for the first sub precharge period of time t1, and the dummy scan line DSL is coupled to the non-discharge source. Accordingly, the first data line D1 is precharged with an upward slope as shown in FIG. 3B.

Then, the second scan line S2 is coupled to the non-luminescent source for the second sub precharge period of time t2, and the dummy scan line DSL is coupled to a discharge source, e.g. ground. Accordingly, the precharge current Pl1 for precharging the first data line D1 flows into the ground through the dummy scan line DSL. Hence, the first data line D1 is precharged up to gray scale of about 40% corresponding to the second display data with a downward slope as shown in B of FIG. 3B. In other words, the first data line D1 is precharged to a constant level for the second sub precharge period of time t2 irrespective of overshooting phenomenon as shown in FIG. 3B.

Subsequently, the data driving circuit 214 provides data current having gray scale of about 40% corresponding to the second display data to the first data line D1 for a luminescent period of time It. Here, the second scan line S2 is coupled to the ground.

Hereinafter, a luminescent process when a first scan line S1 is connected to a ground will be compared with that when a second scan line S2 is connected to the ground. Here, it is assumed that pixels E21 and E31 of the pixels E11 to E41 do not emit a light.

The data lines D1 to D4 are precharged up to a level corresponding to desired gray scale for the precharge period of time, especially the second sub precharge period of time irrespective of overshooting phenomenon, and so the pixels E11 and E41 emit light having the desired gray scale when the first scan line S1 is coupled to the ground.

The data lines D1 to D4 are precharged up to a level corresponding to desired gray scale for the precharge period of time, especially the second sub precharge period of time irrespective of overshooting phenomenon, and so the pixels E11 to E41 emit light having the desired gray scale when the second scan line S2 is coupled to the ground.

Accordingly, in case that a pixel E11 corresponding to the first scan line S1 is designed to have same gray scale as a pixel E12 corresponding to the second scan line S2, the pixel E11 emits a light having the same gray scale as the pixel E12. Hence, cross-talk phenomenon is occurred not in the light emitting device of the present invention.

FIG. 4 is a block diagram illustrating a light emitting device according to another embodiment of the present invention.

In FIG. 4, the light emitting device of the present invention includes a panel 400, a controller 402, a scan driving circuit 404, a discharging circuit 406, a precharging circuit 408, a dummy scan driving circuit 410 and a data driving circuit 412.

Since the elements in the light emitting device of the present invention except the scan driving circuit 404 is the same as in FIG. 2, any further description concerning to the same elements will be omitted.

The scan driving circuit 404 is disposed in one direction unlike the scan driving circuits 204 and 206 in FIG. 2, and transmits scan signals to scan lines S1 to S4.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. A light emitting device comprising:
data lines disposed in a first direction;
scan lines disposed in a second direction different from the first direction;
at least one dummy scan line coupled to one or more data line; and
a dummy scan driving circuit configured to couple the dummy scan line to a discharge source for a part of a precharge period of time.

2. The light emitting device of claim 1, wherein the discharge source is ground.

3. The light emitting device of claim 1, wherein the dummy scan driving circuit configured to couple the dummy scan line to a non-discharge source having the same magnitude as a driving voltage of the light emitting device for the other time of the precharge period of time.

4. The light emitting device of claim 1, further comprising:
a scan driving circuit configured to provide scan signals to the scan lines;
a precharging circuit configured to provide precharge current to the data lines for the precharge period of time; and
a data driving circuit configured to provide data currents to the data lines.

5. The light emitting device of claim 1, further comprising:
a first scan driving circuit configured to provide first scan signals to a part of the scan lines;
a second scan driving circuit configured to provide second scan signals to the other scan lines;
a precharging circuit configured to provide precharge current to the data lines for the precharge period of time; and
a data driving circuit configured to provide data currents to the data lines.

6. The light emitting device of claim 1, wherein the light emitting device is organic electroluminescent device.

7. A light emitting device comprising:
data lines disposed in a first direction;
scan lines disposed in a second direction different from the first direction;
a precharging circuit configured to provide precharge current to at least one data line for a precharge period of time; and
a dummy scan driving circuit configured to discharge the data line precharged by the precharge current for some of the prechage period of time.

8. The light emitting device of claim 7, wherein the dummy scan driving circuit configured to couple the precharged data line to a discharge source for the some of the precharge period of time.

9. The light emitting device of claim 8, wherein the discharge source is ground.

10. The light emitting device of claim 8, wherein the dummy scan driving circuit configured to couple the precharged data line to a non-discharge source having the same magnitude as a driving voltage of the light emitting device for the other time of the precharge period of time.

11. The light emitting device of claim 7, further comprising:
a scan driving circuit configured to provide scan signals to the scan lines; and
a data driving circuit configured to provide data currents to the data lines.

12. The light emitting device of claim 7, further comprising:
a first scan driving circuit configured to provide first scan signals to a part of the scan lines;
a second scan driving circuit configured to provide second scan signals to the other scan lines; and
a data driving circuit configured to provide data currents to the data lines.

13. The light emitting device of claim 7, wherein the light emitting device is organic electroluminescent device.

14. A method of driving a light emitting device having a plurality of pixels formed in cross areas of data lines and scan lines, comprising:
providing precharge current to one or more data line for a precharge period of time, thereby precharging the data line; and
discharging the precharged data line for some of the precharge period of time.

15. The method of claim 14, wherein the step of discharging the precharged data line includes:
coupling the precharged data line to a ground for the some of the precharged period of time.

16. The method of claim 14, further comprising:
providing scan signals to the scan lines; and
providing data currents synchronized with the scan signals to the data lines.

17. A method of driving a light emitting device having a plurality of pixels formed in cross areas of data lines and scan lines, comprising:
providing precharge current to one or more data line for a precharge period of time, thereby precharging the data line; and
providing data current to the precharged data line,
wherein waveform of the precharge current has an upward slope for a first sub precharge period of time of the precharge period of time, and has a downward slope for a second sub precharge period of time of the precharge period of time.

18. The method of claim 17, wherein the waveform is stabilized to a first level after falling for the second sub precharge period of time.

19. The method of claim 18, further comprising:
providing data current to the precharged data line,
wherein a second level corresponding to the data current is substantially identical to the first level.

20. The method of claim 18, further comprising:
transmitting scan signals to the scan lines.
